(19) United States
(12) Patent Application Publication
(10) Pub. No.: US 2013/0007779 A1
(43) Pub. Date: Jan. 3, 2013

(54) TRAY FOR PREVENTING GREASE SCATTERING

(75) Inventors: Jaesung LEE, Seoul (KR); Changwan EUN, Seoul (KR)

(73) Assignee: HITACHI-LG DATA STORAGE KOREA, INC., Seoul (KR)

(21) Appl. No.: 13/538,316

(22) Filed: Jun. 29, 2012

(30) Foreign Application Priority Data
Jun. 29, 2011 (KR) 10-2011-0063566

(51) Int. Cl. G11B 17/04

(52) U.S. Cl. 720/613; G9B/17.013

(57) ABSTRACT

The present invention is related to a tray of an optical disc drive. In a tray according to one embodiment of the present invention, a flutter hole is formed in the middle of the tray providing space through which an optical pick-up moves toward an inner or outer circumferential area of an optical disc and a guide vane is formed to prevent contamination of the optical disc caused as grease spread on a lead screw of a sled motor for moving the optical pick-up moves according to air flow due to rotation of the optical disc. The guide vane can be formed only in a surface in which the lead screw is installed among two vertical side surfaces forming a boundary of a flutter hole of the tray and the guide vane can be formed at a position corresponding to an outer circumferential area of the optical disc.

### BACKGROUND

1. Field

The present invention relates to a tray of an optical disc drive. More specifically, the present invention relates to a tray for preventing scattering of grease spread on screws of a sled motor in an optical disc drive (ODD) for recording or playing data to or from an optical disc such as a CD, DVD, or BD.

2. Related Art

In general, as shown in FIG. 1, an optical disc drive (ODD) is equipped with a tray 10 for loading an optical disc 20, where a flutter hole, for example, in the shape of an ellipse is formed in the middle of the tray 10.

As shown in FIG. 2, an optical pick-up 12 installed in a lower part of the flutter hole moves in a horizontal direction being engaged with a lead screw rotated by a sled motor; thus clearance between the optical pick-up 12 and a spindle motor 11 is made to be small or large.

For example, if a tray containing an optical disc is inserted into the inside of an optical disc drive, the spindle motor 11 moves up and clamps the optical disc and then rotates with high speed.

Since the rotating sled motor makes the optical pick-up 12 move to a position close to the spindle motor 11, the optical pick-up 12 accesses an inner circumferential area of the disc rotating with high speed by the spindle motor 11. For example, as shown in FIG. 3, the sled motor 14 can be installed in the right hand side of the optical pick-up 12 and a moderate amount of grease is spread on the lead screw 13 rotated by the sled motor 14.

However, as described above, if an optical disc in a tray rotates with high speed by the spindle motor, air flow is generated due to the high speed rotation of the optical disc. Therefore, a grease scattering phenomenon occurs, where part of grease spread on the lead screw floats upward through the flutter hole of the tray.

Therefore, as shown in FIG. 4, a recording surface of the optical disc is contaminated; accordingly, a critical error may occur in data recording or playing of an optical disc.

### SUMMARY

To solve the problem described above, the present invention has been made in an effort to provide a tray preventing a grease scattering phenomenon, where grease spread on a lead screw of a sled motor floats upward through a flutter hole of a tray due to high speed rotation of an optical disc.

A tray for loading an optical disc into the inside of an optical disc drive according to the present invention forms a flutter hole in the middle of the tray, wherein the flutter hole provides space through which an optical pick-up moves toward an inner or outer circumferential area of the optical disc and a guide vane to prevent contamination of the optical disc caused as grease spread on a lead screw of a sled motor for moving the optical pick-up moves according to the air flow due to rotation of the optical disc.

In one embodiment, the guide vane can be formed only in a vertical side surface in which the lead screw is installed between two vertical side surfaces forming the boundary of a flutter hole of the tray.

In one embodiment, the guide vane can be formed in a position corresponding to an outer circumferential area of the optical disc and the width of the guide vane can be 2 cm in an inner or outer circumferential direction.

In one embodiment, the guide vane can protrude toward the flutter hole with a height not interfering with a movement path of the optical pick-up.

In one embodiment, the guide vane can be made through injection molding as a single body together with the tray.

An optical disc drive according to another embodiment of the present invention comprises a tray for loading an optical disc into the inside of the optical disc drive; a spindle motor for rotating the optical disc; an optical pick-up for recording data to or reading out data from the optical disc; and a sled motor for moving the optical pick-up toward an inner or outer circumferential area through a lead screw, wherein a flutter hole is formed in the middle of the tray providing space through which the optical pick-up moves toward an inner or outer circumferential area of the optical disc and a guide vane is formed in the tray to prevent contamination of the optical disc caused as grease spread on the lead screw moves according to air flow due to rotation of the optical disc.

Contamination of a data recording surface of an optical disc because of grease can be prevented efficiently.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 illustrates a tray according to the prior art;

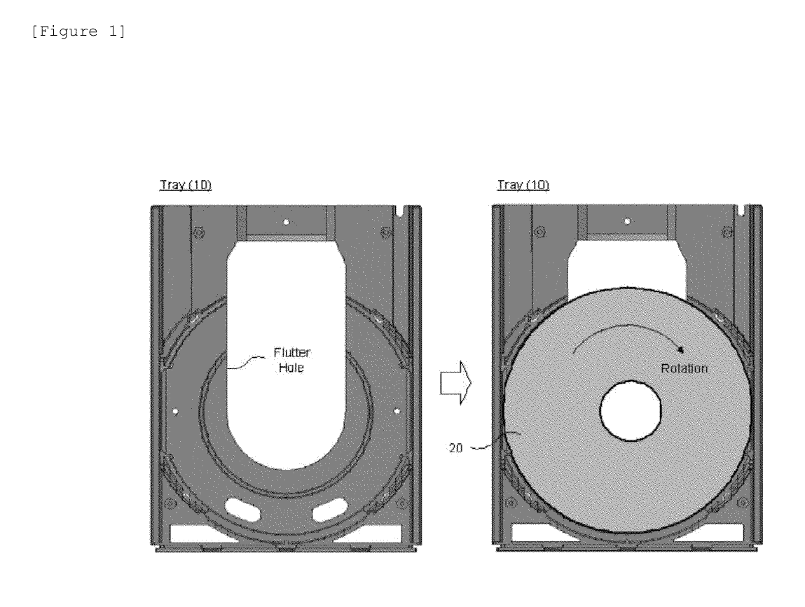

FIG. 2 illustrates a case where an optical pick-up and a spindle motor are installed in a lower side of a tray;

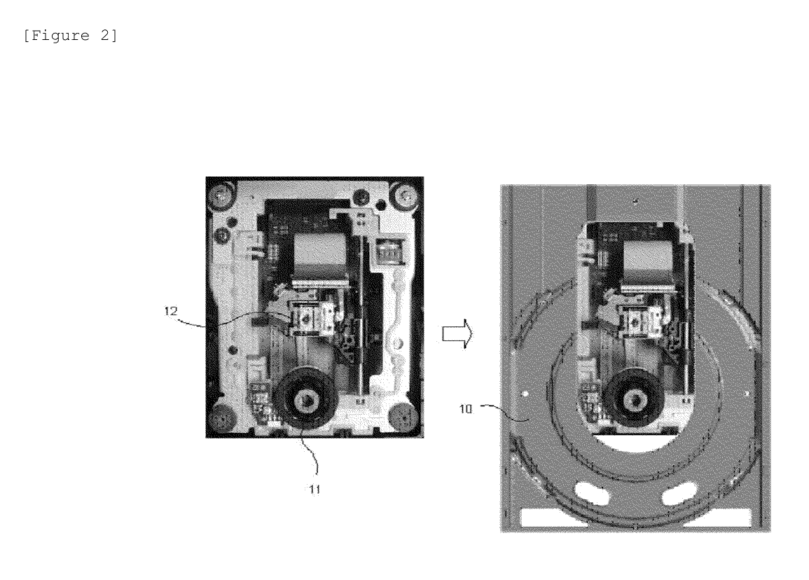

FIG. 3 illustrates a case where grease is spread on a lead screw of a sled motor;

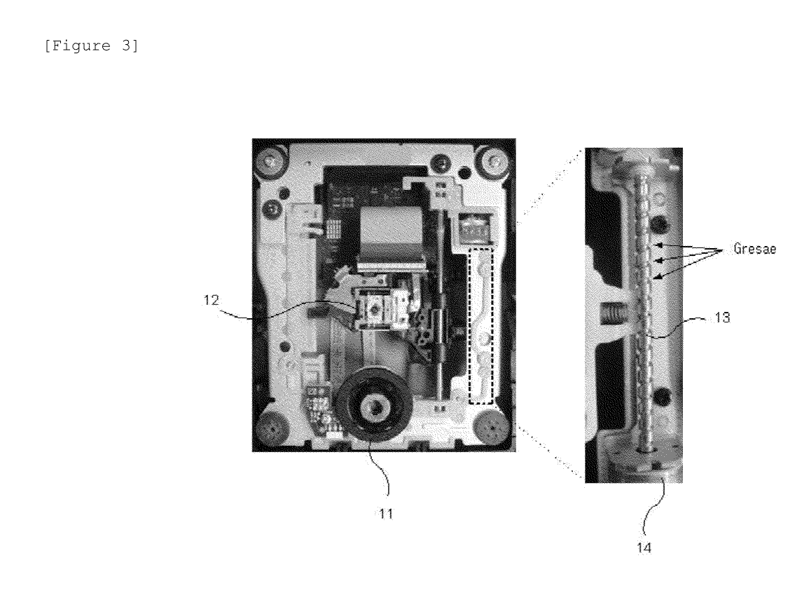

FIG. 4 illustrates an embodiment of a tray for preventing grease scattering according to the present invention;

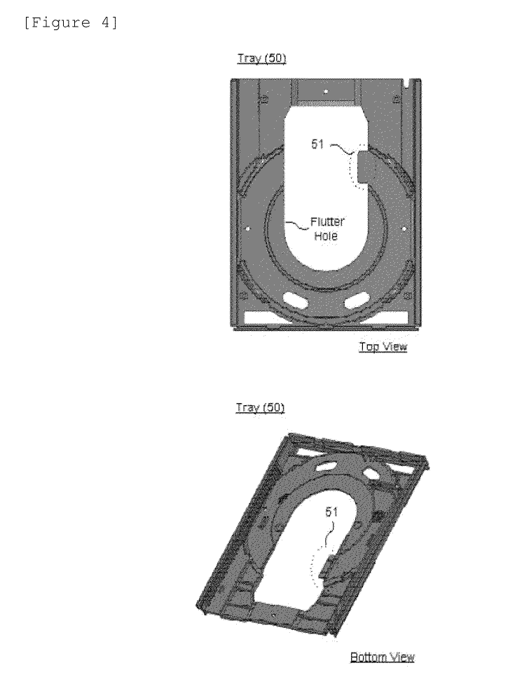

FIG. 5 illustrates air flow inside an ODD according to high speed rotation of an optical disc shown on a surface cut along a vertical direction in parallel to the front surface of the ODD; and

FIG. 6 is a test result of a grease scattering phenomenon according to the present invention.

### DETAILED DESCRIPTION OF THE INVENTION

In what follows, preferred embodiments of a tray for preventing grease scattering according to the present invention will be described in detail with reference to appended drawings.

First, a tray for preventing grease scattering according to the present invention applies to trays incorporated into various types of optical disc drives (ODDs) for recording data to or reading out data from an optical disc such as a CD, DVD, or BD.

Internal flow speed due to disc rotation is beyond a few m/sec to a few tens of m/sec. According to a simulation, air flow accelerated by a disc passes a lead screw located at a lower part of the tray and is discharged to an upper part of the tray. Due to such a flow pattern, grease particles spread on the lead screw may be scattered, thus contaminating a disc recording surface.

Therefore, a tray according to the present invention, for instance, to prevent a grease scattering phenomenon, where part of grease spread on a lead screw of a sled motor floats upward through a flutter hole, a grease blocking protrusion or guide vane of a predetermined size protruding toward the flutter hole is formed in the tray; the guide vane can be made through injection molding as a single body together with a tray.

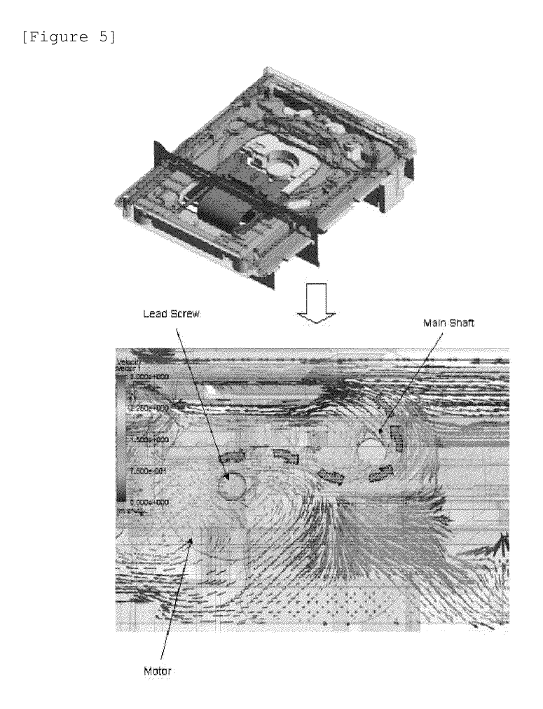

For example, as shown in FIG. 5, in the middle of a tray 50 where an optical disc is loaded, a flutter hole in the shape of an ellipse is formed to enable an optical pick-up to move horizontally toward an inner or outer circumferential area of an optical disc according to rotation of a sled motor.

A protruding guide vane 15 is formed in the tray toward the flutter hole, preventing grease floating along an upper direction from a lead screw of the sled motor due to air flow according to high speed rotation of an optical disc from being scattered on the optical disc.

The guide vane 51 is formed only in a vertical side surface in which the lead screw is installed between both of vertical side surfaces forming the boundary of a flutter hole of the tray. For example, as shown in FIG. 5, if a lead screw of the sled motor is installed at the right side of the ODD when viewed from the front of the ODD, the guide vane 51 may protrude with a predetermined size from the right side surface which forms the boundary of the flutter hole.

On the other hand, if a lead screw of the sled motor is installed at the left side of the ODD, the guide vane 51 may protrude from the left side surface which forms the boundary of the flutter hole.

Meanwhile, protrusion height of the guide vane 51 is determined such that it does not interfere or collide with an optical pick-up moving toward an inner or outer circumferential area by a sled motor, where the guide vane 51 may protrude with a height smaller than the clearance between a horizontal moving path of the optical pick-up and the flutter hole boundary of a tray. For example, if clearance between the optical pick-up and the flutter hole is 3 mm, the guide vane 51 protrudes with a height of 2 mm, which is smaller than the clearance, preventing collision with the optical pick-up.

FIG. 5 illustrates air flow inside an ODD according to high speed rotation of an optical disc shown on a surface (a cross section cut from the position where an outer circumferential area of an optical disc is located) cut along a vertical direction in parallel to the front surface of the ODD. As shown in FIG. 5, a grease scattering phenomenon occurs, where grease spread on a lead screw of a sled motor passes a main shaft and floats upward due to air flow caused by high speed rotation of an optical disc.

Taking account of the fact above, the guide vane 51 may protrude toward the flutter hole at the position corresponding to an outer circumferential area (an outer circumferential area of an optical disc with a radius of 12 cm) of an optical disc in a tray containing the optical disc.

Therefore, grease floating upward due to air flow does not reach the data recording surface of an optical disc as it is blocked by the guide vane 51 in the tray protruding toward the flutter hole, thereby efficiently preventing contamination of an optical disc due to grease.

Meanwhile, a tray can load both kinds of optical discs with a radius of 8 cm and 12 cm into the inside of an optical disc drive. To load or unload an optical disc with a radius of 8 cm to and from an optical disc drive while the optical disc is fixed inside the tray, a step is formed between a first loading surface for loading a disc with a radius of 8 cm and a second loading surface for loading a disc with a disc of 12 cm. Since the guide vane 51 according to the present invention can be formed on the second loading surface for loading an optical disc with a radius of 12 cm and the second loading surface has a size of 2 cm ((12−8)/2) toward an inner and outer circumferential direction, the guide vane 51 has a width of about 2 cm along an inner and outer circumferential direction.

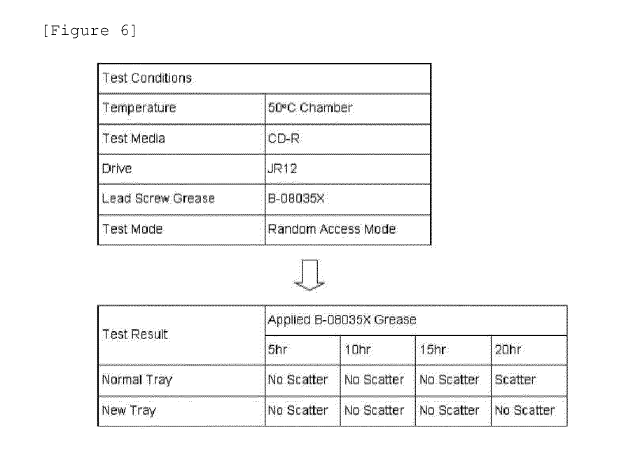

FIG. 6 is a test result of a grease scattering phenomenon according to the present invention. The test conditions of FIG. 6 are as follows. Chamber temperature is 50° Celsius; test media is CD-R; drive is a CD drive (e.g., JR12); grease for lead screw is B-08035X; and test mode is a random access mode.

It turned out from the test that in the case of a conventional tray, optical discs were contaminated due to grease scattering phenomenon at the time when 20 hours were passed, whereas in the case of a new tray according to the present invention, optical discs remained uncontaminated against the grease scattering phenomenon even at the time when 20 hours were passed.

Preferred embodiments of the present invention have been introduced for the illustration purpose only. Therefore, it should be noted that various improvements, modifications, substitutions of, or additions to the present invention are possible without departing from the technical principles and scope of the present invention.

What is claimed is:

1. A tray for loading an optical disc into an optical disc drive, wherein
a flutter hole is formed in a middle of the tray providing space through which an optical pick-up moves toward an inner or outer circumferential area of an optical disc and
a guide vane is formed to prevent contamination of the optical disc caused as grease spread on a lead screw of a sled motor for moving the optical pick-up moves according to air flow due to rotation of the optical disc.

2. The tray of claim 1, wherein the guide vane is formed only in a vertical side surface in which the lead screw is installed among two vertical side surfaces forming a boundary of a flutter hole of the tray.

3. The tray of claim 1, wherein the guide vane is formed at a position corresponding to an outer circumferential area of the optical disc.

4. The tray of claim 3, wherein a width of the guide vane is 2 cm in an inner or outer circumferential direction.

5. The tray of claim 1, wherein the guide vane protrudes toward the flutter hole with a height not interfering with a movement path of the optical pick-up.

6. The tray of claim 1, wherein the guide vane is made through injection molding as a single body together with the tray.

7. An optical disc drive, comprising:
a tray for loading an optical disc into the inside of an optical disc drive;
a spindle motor for rotating the optical disc;
an optical pick-up for recording data to or reading out data from the optical disc; and
a sled motor for moving the optical pick-up toward an inner or outer circumferential area through a lead screw,
wherein a flutter hole is formed in a middle of the tray providing space through which the optical pick-up moves toward an inner or outer circumferential area of the optical disc and a guide vane is formed in the tray to prevent contamination of the optical disc caused as grease spread on the lead screw moves according to air flow due to rotation of the optical disc.

8. The optical disc drive of claim 7, wherein the guide vane is formed only in a vertical side surface in which the lead screw is installed among two vertical side surfaces forming a boundary of a flutter hole of the tray.

9. The optical disc drive of claim 7, wherein the guide vane is formed at a position corresponding to an outer circumferential area of the optical disc.

10. The optical disc drive of claim 9, wherein a width of the guide vane is 2 cm in an inner or outer circumferential direction

11. The optical disc drive of claim 7, wherein the guide vane protrudes toward the flutter hole with a height not interfering with a movement path of the optical pick-up.

12. The optical disc drive of claim 7, wherein the guide vane is made through injection molding as a single body together with the tray.
